(19) United States
(12) Patent Application Publication
(10) Pub. No.: US 2026/0024946 A1
(43) Pub. Date: Jan. 22, 2026

(54) FIRST CONNECTOR AND CONNECTOR ASSEMBLY

(71) Applicant: SUMITOMO WIRING SYSTEMS, LTD., Mie (JP)

(72) Inventor: Yusuke YAMOTO, Mie (JP)

(21) Appl. No.: 19/264,156

(22) Filed: Jul. 9, 2025

(30) Foreign Application Priority Data
Jul. 17, 2024 (JP) 2024-113992

(51) Int. Cl. H01R 13/629

(52) U.S. Cl. CPC H01R 13/62955; H01R 13/62938

(57) ABSTRACT

A first connector includes: a first housing that is mateable with a second housing, and a lever attached to the first housing to be rotatable between mating start orientation and mating completion orientation. The first housing includes a cam pin. The lever includes an operation portion serving as an effort point, a cam groove into which the cam pin is inserted and is engageable with the cam pin, and a bearing portion into which a shaft portion provided in the second housing is inserted. The cam groove is formed in an elongated hole, and is provided between the operation portion and the bearing portion. The cam groove causes a force for pressing the first housing into the second housing to act on the cam pin when the lever is rotated about the bearing portion serving as a fulcrum from the mating start orientation to the mating completion orientation.

### CROSS-REFERENCE TO RELATED APPLICATIONS

This application is based on and claims priority from Japanese Patent Application No. 2024-113992, filed on Jul. 17, 2024, with the Japan Patent Office, the disclosure of which is incorporated herein in its entirety by reference.

### TECHNICAL FIELD

The present disclosure relates to a first connector and a connector assembly.

### BACKGROUND

Heretofore, there are known connector assemblies in which a first connector is mated with a second connector using the force amplification effect of a lever (for example, see JP 2018-200767 A). The first connector includes a first housing having a support shaft and a lever attached to the first housing. The second connector includes a second housing having a cam pin. The lever includes an operation portion, a bearing portion into which the support shaft is inserted, and a cam groove into which the cam pin is inserted. The bearing portion is provided between the operation portion and the cam groove. In the connector assemblies, the cam pin is drawn into the cam groove by rotating the lever about the support shaft, and the second housing is thereby drawn toward the first housing. Accordingly, the first connector and the second connector can be mated with each other by operating the lever with a small operating force.

### SUMMARY

Incidentally, if the sizes of the above connector assemblies are reduced, the operation portion serving as an effort point, the bearing portion serving as a fulcrum, and the cam groove serving as a load point are positioned closer to one another. For this reason, the lever ratio of the lever configured as a first-class lever is small. Accordingly, a problem occurs in that the effect of reducing the operating force of the lever is small.

An object of the present disclosure is to provide a first connector and a connector assembly that can suitably reduce an operating force of a lever even if the size of the first connector is reduced.

A first connector according to the present disclosure includes: a first housing that is mateable with a second housing of a second connector, and a lever that is attached to the first housing so as to be rotatable between mating start orientation and mating completion orientation, wherein the first housing includes a cam pin, the lever includes an operation portion serving as an effort point, a cam groove into which the cam pin is inserted and that is engageable with the cam pin, a bearing portion into which a shaft portion provided in the second housing is inserted, the cam groove is formed in an elongated hole, and is provided between the operation portion and the bearing portion, and the cam groove causes a force for pressing the first housing into the second housing to act on the cam pin when the lever is rotated about the bearing portion serving as a fulcrum from the mating start orientation to the mating completion orientation.

A first connector according to the present disclosure has an effect that an operating force of a lever can be suitably reduced even if the size of the first connector is reduced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector assembly according to an embodiment of the present disclosure.

FIG. 2 is an exploded perspective view showing the connector assembly according to the embodiment.

FIG. 3 is a perspective view showing a second connector according to the embodiment.

FIG. 4 is an exploded perspective view showing a first connector according to the embodiment.

FIG. 5 is a cross-sectional view showing a mating process of the connector assembly according to the embodiment.

FIG. 6 is a cross-sectional view showing a mating process of the connector assembly according to the embodiment.

FIG. 7 is a cross-sectional view showing a mating process of the connector assembly according to the embodiment.

FIG. 8 is a cross-sectional view showing a mating process of the connector assembly according to the embodiment.

FIG. 9 is a cross-sectional view showing a mating completion state of the connector assembly according to the embodiment.

FIG. 10 is a cross-sectional view showing the mating completion state of the connector assembly according to the embodiment.

FIG. 11 is a cross-sectional view (a cross-sectional view taken along the line 11-11 in FIG. 6) showing the connector assembly according to the embodiment.

FIG. 12 is a cross-sectional view (a cross-sectional view taken along the line 12-12 in FIG. 10) showing the connector assembly according to the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Disclosure

First, an embodiment of the present disclosure will be listed and described.
[1] A first connector according to the present disclosure includes: a first housing that is mateable with a second housing of a second connector, and a lever that is attached to the first housing so as to be rotatable between mating start orientation and mating completion orientation, the first housing includes a cam pin, the lever includes an operation portion serving as an effort point, a cam groove into which the cam pin is inserted and that is engageable with the cam pin, a bearing portion into which a shaft portion provided in the second housing is inserted, the cam groove is formed in an elongated hole, and is provided between the operation portion and the bearing portion, and the cam groove causes a force for pressing the first housing into the second housing to act on the cam pin when the lever is rotated about the bearing portion serving as a fulcrum from the mating start orientation to the mating completion orientation.

With this configuration, the cam groove provided in the lever is provided between the operation portion and the bearing portion. For this reason, the lever is provided with the operation portion serving as an effort point and the bearing portion serving as a fulcrum, which are disposed with the cam groove serving as a load point therebetween. Therefore, compared with a conventional configuration in which a bearing portion serving as a fulcrum is provided between an operation portion and a cam groove, the distance between the bearing portion serving as a fulcrum and the operation portion serving as an effort point can be set to be long, and the lever ratio can be set to be larger. As a result, even if the size of the first connector is reduced, it is possible to suitably suppress a decrease in the effect of reducing the operating force of the lever. Accordingly, even if the size of the first connector is reduced, it is possible to suitably reduce the operating force of the lever when mating the first connector and the second connector with each other. Note that when the distance between the bearing portion serving as a fulcrum and the operation portion serving as an effort point is denoted by L1, and the distance between the bearing portion serving as a fulcrum and the cam groove serving as a load point is denoted by L2, L1/L2 is defined as a lever ratio.
[2] A connector assembly according to the present disclosure is a connector assembly that includes: a first connector and a second connector that is to be mated with the first connector, wherein the first connector includes: a first housing that includes a cam pin; and a lever that is attached to the first housing so as to be rotatable between mating start orientation and mating completion orientation, the second connector includes: a second housing that is mateable with the first housing; and a shaft portion, the lever includes an operation portion serving as an effort point, a cam groove into which the cam pin is to be inserted and that is engageable with the cam pin, and a bearing portion into which the shaft portion is to be inserted, the cam groove is formed in an elongated hole, and is provided between the operation portion and the bearing portion, and the cam groove causes a force for pressing the first housing into the second housing to act on the cam pin when the lever is rotated about the bearing portion serving as a fulcrum from the mating start orientation to the mating completion orientation.

With this configuration, it is possible to achieve a similar effect to the first connector in the above [1].
[3] In the above [2], a distance between the bearing portion and the cam groove may be shorter than a distance between the cam groove and the operation portion.

With this configuration, the lever ratio can be set to be larger. As a result, even if the sizes of the first connector and the second connector are reduced, it is possible to suitably reduce the operating force of the lever.
[4] In the above [2] or [3], the lever may include a first end portion and a second end portion in a first direction intersecting a mating direction in which the first housing is mated with the second housing, the bearing portion may be provided at the first end portion, and the operation portion may be provided at the second end portion.

With this configuration, the distance between the bearing portion serving as a fulcrum and the operation portion serving as an effort point can be set to be longer, and the lever ratio can be set to be larger. As a result, even if the sizes of the first connector and the second connector are reduced, it is possible to suitably reduce the operating force of the lever.
[5] In any one of the above [2] to [4], the cam groove may be formed to have an oblong shape having two parallel lines and two semicircles in plan view, the cam pin may be formed in a cylindrical shape, the shortest distance between the two parallel lines may be longer than a diameter of the cam pin, and the cam groove may be formed such that, when the lever is disposed in the mating completion orientation, the two parallel lines extend parallel to a second direction orthogonal to the mating direction in which the first housing is mated with the second housing.

With this configuration, when the lever is disposed in the mating completion orientation, the two parallel lines of the cam groove extend parallel to the second direction orthogonal to the mating direction. Accordingly, it is possible to cause a force for pressing the first housing into the second housing (in other words, a pressing force along the mating direction) to act on the cam pin using a surface orthogonal to the mating direction, immediately before mating completion. Therefore, at the time of mating completion when a pressing force along the mating direction is most necessary, it is possible to cause the largest pressing force to act on the cam pin using the surface orthogonal to the mating direction. As a result, it is possible to suitably reduce the operating force of the lever immediately before mating completion.
[6] In any one of the above [2] to [5], the lever may include a first engagement portion, the first housing may include a first restriction portion for restricting rotation of the lever in a first rotational direction from the mating start orientation to the mating completion orientation, and the first restriction portion may be engageable with the first engagement portion when the lever is disposed in the mating start orientation.

With this configuration, when the lever is disposed in the mating start orientation, the first engagement portion of the lever is engaged with the first restriction portion of the first housing. Due to engagement between the first engagement portion and first restriction portion, it is possible to restrict rotation of the lever in the first rotational direction from the mating start orientation toward the mating completion orientation. As a result, it is possible to suitably suppress unintentional rotation of the lever in the first rotational direction in a state where the lever is disposed in the mating start orientation.
[7] In the above [6], the second housing may include: a mating recessed portion into which the first housing is to be mated and a farther wall provided at a farther end of the mating recessed portion, the first engagement portion may include a first flexible piece that is flexibly deformable and a first engagement protrusion that protrudes from the first flexible piece, the first housing may include a front wall facing the farther wall, and a first insertion groove with which the first engagement protrusion is to be mated, the first insertion groove may be open in the mating direction in which the first housing is mated with the second housing, the first insertion groove may extend from the front wall along a mating-opposite direction that is a direction opposite to the mating direction, the first restriction portion may be formed by an inner surface of the first insertion groove, and the second housing may include a disengagement portion that is inserted into the first insertion groove along the mating-opposite direction and disengages the first restriction portion and the first engagement protrusion from each other.

With this configuration, as the first housing and the second housing are mated with each other, the disengagement portion provided in the second housing is inserted into the first insertion groove along the mating-opposite direction. Due to this disengagement portion, the first restriction portion and the first engagement protrusion are disengaged from each other. When the first restriction portion and the first engagement protrusion are disengaged from each other in this manner, it is possible to allow rotation of the lever in the first rotational direction from the mating start orientation toward the mating completion orientation.
[8] In the above [7], the shaft portion may be formed to be accommodated in the bearing portion when the first restriction portion and the first engagement protrusion are disengaged from each other due to the disengagement portion.

With this configuration, when rotation of the lever in the first rotational direction is allowed, the shaft portion serving as a fulcrum can be accommodated in the bearing portion. Accordingly, it is possible to suitably keep the shaft portion from coming loose from the bearing portion when the lever rotates in the first rotational direction.
[9] In any one of the above [2] to [8], the lever may include a second engagement portion, the first housing may include a second restriction portion for restricting rotation of the lever in a second rotational direction from the mating completion orientation toward the mating start orientation, and the second restriction portion may be engageable with the second engagement portion when the lever is disposed in the mating completion orientation.

With this configuration, when the lever is disposed in the mating completion orientation, the second engagement portion of the lever is engaged with the second restriction portion of the first housing. Due to engagement between the second engagement portion and second restriction portion, it is possible to restrict rotation of the lever in the second rotational direction from the mating completion orientation toward the mating start orientation. As a result, it is possible to suitably suppress unintentional rotation of the lever in the second rotational direction in a state where the lever is disposed in the mating completion orientation.
[10] In the above [9], the second engagement portion may include a second flexible piece that is flexibly deformable and a second engagement protrusion that protrudes from the second flexible piece and is engageable with the second restriction portion, a lengthwise direction of the second flexible piece may match the mating direction in which the first housing is mated with the second housing in a state where the lever is disposed in the mating completion orientation, the second engagement protrusion may be provided at an intermediate position in the lengthwise direction of the second flexible piece, the second engagement protrusion may protrude in a third direction intersecting the lengthwise direction of the second flexible piece, the operation portion may include a through hole that passes through the operation portion in the mating direction, and the second flexible piece may extend from the second engagement protrusion to the inside of the through hole.

With this configuration, the second engagement protrusion and the second restriction portion can be disengaged from each other by flexing the second flexible piece. Accordingly, when the first housing is detached from the second housing, the lever can be suitably rotated in the second rotational direction. In addition, the second flexible piece extends to the inside of the through hole provided in the operation portion, and thus it is possible to easily perform an operation of the second flexible piece, in other words an operation of disengaging the second engagement protrusion and the second restriction portion from each other.

### Details of Embodiments of the Present Disclosure

Specific examples of a first connector and a connector assembly according to the present disclosure will be described below with reference to the drawings. In the drawings, parts of the configurations may be shown in an exaggerated or simplified manner for convenience of description. Moreover, dimensional ratios of portions may be different between figures. “Parallel” and “orthogonal” in the present specification include not only being exactly parallel and orthogonal but also approximately parallel and orthogonal within a range in which operations and effects of the present embodiment can be achieved. “Facing” in the present specification refers to surfaces or members being positioned in front of each other, and includes not only cases where they are positioned precisely in front of each other but also cases where they are partially positioned in front of each other. “Facing” in the present specification also includes both cases where two portions are disposed with a member other than the two portions interposed therebetween and cases where nothing is interposed between two portions. In addition, terms “first”, “second”, “third”, and the like in the present specification are used merely to distinguish one target object from another, and are not intended to indicate any priority or ranking. Note that the present invention is not limited to the embodiments disclosed herein, but is defined by the claims, and intended to include all modifications within the meaning and the scope equivalent thereof.

### Overall Configuration of Connector Assembly 1

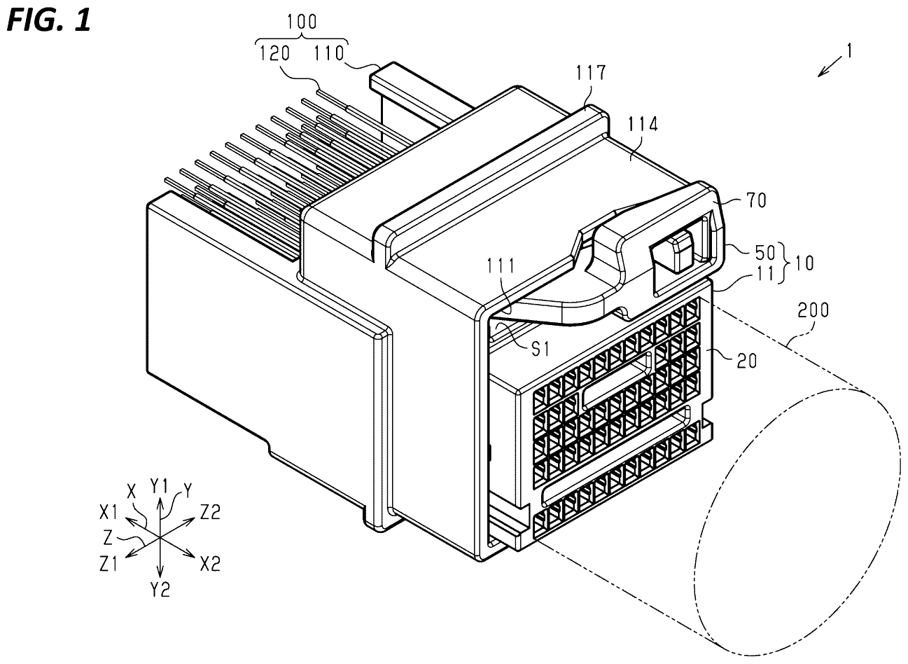

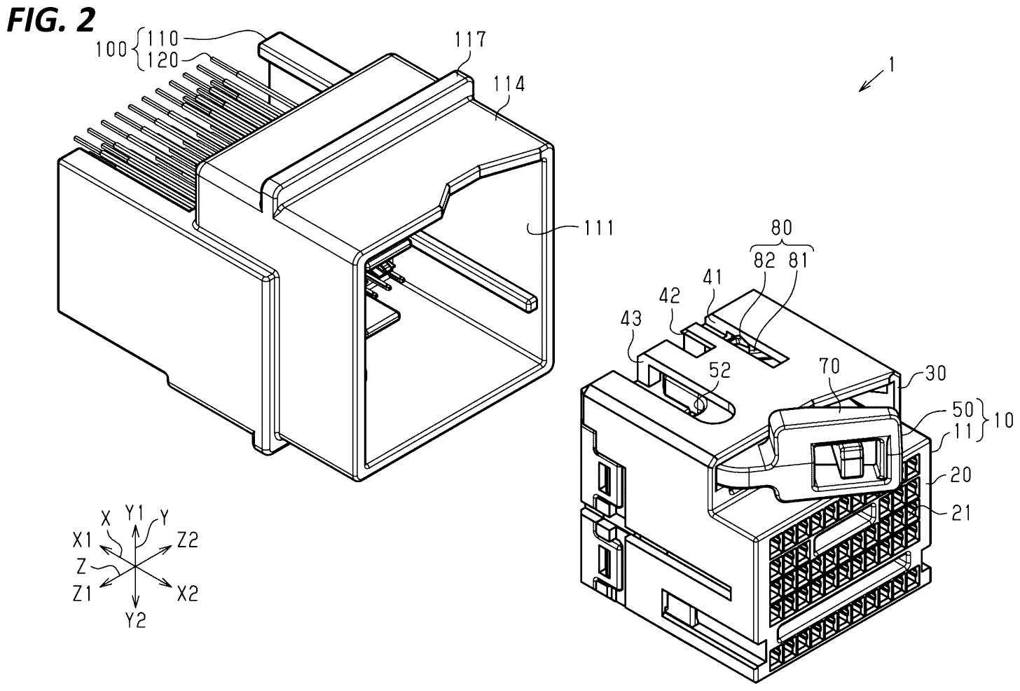

As shown in FIGS. 1 and 2, a connector assembly 1 includes a first connector 10 and a second connector 100 to and from which the first connector 10 is attached and detached. The connector assembly 1 is provided, for example, in a vehicle (not illustrated) such as a hybrid automobile or an electric automobile. The first connector 10 and the second connector 100 electrically connect at least two electrical devices (not illustrated). Examples of such electrical devices include a high-voltage battery, an inverter, a motor, and a relay box.

The drawings illustrate a first axis line X, a second axis line Y that is orthogonal to the first axis line X, and a third axis line Z that is orthogonal to both the first axis line X and the second axis line Y. The drawings also illustrate a forward direction X1 that is one direction along the first axis line X, and a rearward direction X2 that is the other direction along the first axis line X and is opposite to the forward direction X1. Here, the forward direction X1 is a mating direction in which the first connector 10 is mated with the second connector 100. The drawings illustrate an upward direction Y1 that is one direction along the second axis line Y, and a downward direction Y2 that is the other direction along the second axis line Y and is opposite to the upward direction Y1. The drawings illustrate a first width direction Z1 that is one direction along the third axis line Z, and a second width direction Z2 that is the other direction along the third axis line Z and is opposite to the first width direction Z1. Note that the directions in the drawings do not necessarily represent orientation of the first connector 10 and the second connector 100 when they are in use. In addition, directions in the drawings of the second connector 100 will be described based on a state where the second connector 100 is mated with the first connector 10.

### Schematic Configuration of First Connector 10

The first connector 10 includes a first housing 11, a plurality of first terminals (not illustrated) held in the first housing 11, and a lever 50 that is rotatably attached to the first housing 11. The first connector 10 is, for example, a female connector.

As shown in FIG. 1, an electric wire bundle 200 formed by bundling a plurality of electric wires (not illustrated) connected to the first terminals is drawn out in the rearward direction X2, from the end surface in the rearward direction X2 of the first housing 11. Note that, in FIG. 1, for simplification of the figure, the electric wire bundle 200 is illustrated as a single thick line drawn with chain double-dashed lines. In addition, in the figures other than FIG. 1, illustration of the electric wire bundle 200 is omitted,

### Configuration of Second Connector 100

The second connector 100 includes a second housing 110 and a plurality of second terminals 120 held in the second housing 110. The second connector 100 is, for example, a male connector.

The second housing 110 is made of a synthetic resin. The second housing 110 includes a mating recessed portion 111 into which the first connector 10 is mated.

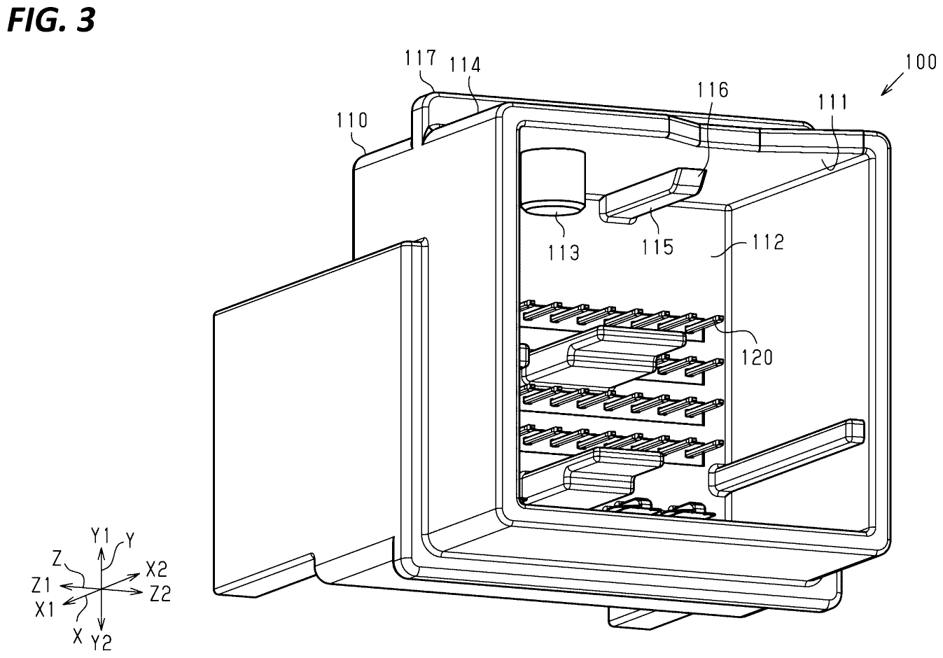

As shown in FIG. 3, the mating recessed portion 111 is formed to be recessed toward the forward direction X1 from the end surface in the rearward direction X2 of the second housing 110. The mating recessed portion 111 is open in the rearward direction X2. The mating recessed portion 111 includes a farther wall 112 provided at the farther end of the mating recessed portion 111. The farther wall 112 is formed to block the opening in the forward direction X1 of the mating recessed portion 111. The mating recessed portion 111 is formed to have a rectangular shape in plan view from the forward direction X1.

A shaft portion 113 is provided on an inner surface of the mating recessed portion 111. The shaft portion 113 is provided on the inner surface of an upper wall 114 provided in the upward direction Y1, from among the walls that constitute the mating recessed portion 111. The shaft portion 113 protrudes in the downward direction Y2 from the inner surface of the upper wall 114, in other words the end surface in the downward direction Y2 of the upper wall 114. The shaft portion 113 is formed in a columnar shape. The shaft portion 113 according to the present embodiment is generally formed in a cylindrical shape.

A disengagement portion 115 is provided on an inner surface of the mating recessed portion 111. The disengagement portion 115 is provided on the inner surface of the upper wall 114. The disengagement portion 115 protrudes in the downward direction Y2 from the inner surface of the upper wall 114. The disengagement portion 115 extends in the rearward direction X2 from the farther wall 112. The disengagement portion 115 is provided at a position further in the second width direction Z2 than the shaft portion 113. The size of the disengagement portion 115 along the second axis line Y is smaller than the size of the shaft portion 113 along the second axis line Y. The end surface in the rearward direction X2 of the disengagement portion 115 is formed as an inclined surface 116. The inclined surface 116 is formed to be inclined in the rearward direction X2 from the edge in the downward direction Y2 thereof toward the edge in the upward direction Y1.

The second housing 110 includes a protrusion portion 117 that protrudes in the upward direction Y1 from the end surface in the upward direction Y1 of the upper wall 114. The protrusion portion 117 extends along the third axis line Z. The protrusion portion 117 extends over the entire upper wall 114 along the third axis line Z. The protrusion portion 117 is used, for example, when the second housing 110 is attached to another component (such as a case or a cover), for example.

The second terminals 120 are configured to be electrically connectable to the first terminals (not illustrated), respectively. The second terminals 120 are, for example, needle-shaped terminals (tubular terminals). The second terminals 120 are held by the farther wall 112 in a form of passing through the farther wall 112 along the first axis line X.

### Configuration of First Housing 11

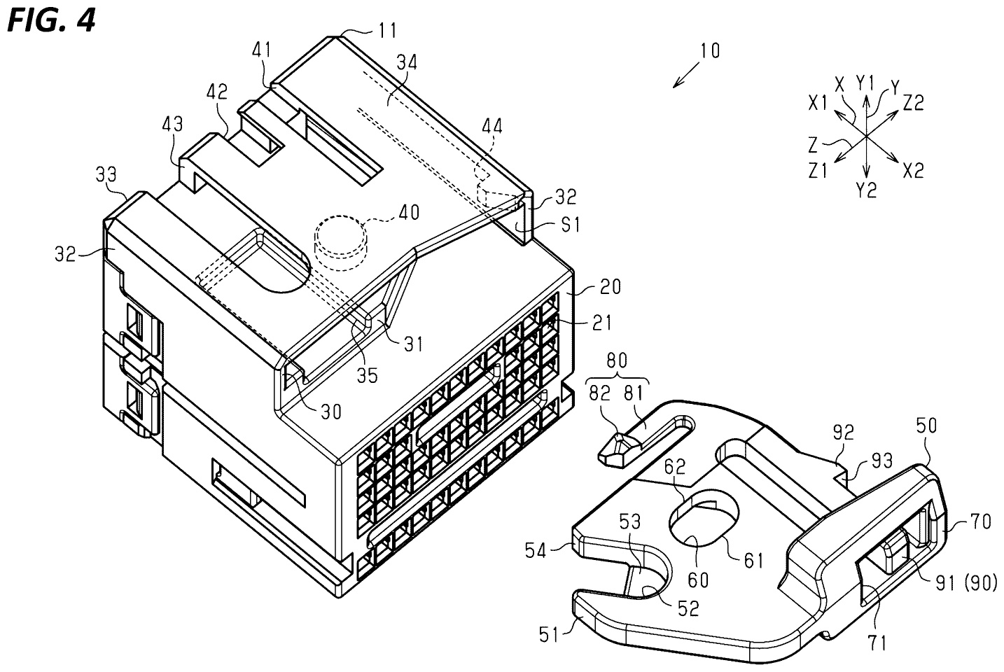

As shown in FIG. 4, the first housing 11 includes a terminal storage portion 20 for accommodating the first terminals, and a lever holding portion 30 for holding the lever 50. The first housing 11 is a single component formed by integrating the terminal storage portion 20 and the lever holding portion 30. The first housing 11 is made of a synthetic resin.

The terminal storage portion 20 includes a plurality of cavities 21 that pass through the first housing 11 along the first axis line X. The cavities 21 respectively accommodate the first terminals (not illustrated). End portions of electric wires that form the electric wire bundle 200 shown in FIG. 1 are respectively connected to the first terminals.

The lever holding portion 30 is provided on the terminal storage portion 20. The lever holding portion 30 includes a wall portion 31, a pair of side walls 32, a front wall 33, and a ceiling wall 34.

The wall portion 31 is provided on the end surface in the upward direction Y1 of the terminal storage portion 20. The end surface in the rearward direction X2 of the wall portion 31 is provided at a position further in the forward direction X1 than the end surface in the rearward direction X2 of the terminal storage portion 20.

A groove portion 35 is provided in the wall portion 31. The groove portion 35 is formed to be recessed in the downward direction Y2 from the end surface in the upward direction Y1 of the wall portion 31. The groove portion 35 extends in the forward direction X1 from the end surface in the rearward direction X2 of the wall portion 31.

A cam pin 40 is provided on the wall portion 31. The cam pin 40 protrudes in the upward direction Y1 from the end surface in the upward direction Y1 of the wall portion 31. The cam pin 40 is formed in a columnar shape. The cam pin 40 according to the present embodiment is generally formed in a cylindrical shape. The cam pin 40 is provided in a central region of the end surface in the upward direction Y1 of the wall portion 31, in plan view from the downward direction Y2. The cam pin 40 is provided at a position further in the second width direction Z2 than the groove portion 35.

The pair of side walls 32 protrude in the upward direction Y1 from the wall portion 31. The pair of side walls 32 are respectively provided at an end portion in the first width direction Z1 of the wall portion 31 and an end portion in the second width direction Z2 of the wall portion 31. The pair of side walls 32 face each other along the third axis line Z. The side walls 32 extend along the first axis line X.

The front wall 33 protrudes in the upward direction Y1 from the wall portion 31. The front wall 33 is provided at the end portion in the forward direction X1 of the wall portion 31. The front wall 33 extends along the third axis line Z. The front wall 33 is formed to couple the pair of side walls 32 to each other. The front wall 33 faces the farther wall 112 (see FIG. 3) of the second housing 110.

The ceiling wall 34 faces the wall portion 31. The ceiling wall 34 is connected to the end portions in the upward direction Y1 of the pair of side walls 32 and the end portion in the upward direction Y1 of the front wall 33. The ceiling wall 34 extends along the first axis line X and the third axis line Z. The ceiling wall 34 has a thickness in the upward direction Y1. The ceiling wall 34 is a wall portion provided at the furthest position in the upward direction Y1 of the first housing 11. Here, the lever 50 is accommodated in a housing space SI surrounded by the ceiling wall 34, the pair of side walls 32, the front wall 33, and the wall portion 31. The housing space S1 is open in the rearward direction X2.

A first insertion groove 41 is provided in the ceiling wall 34. The first insertion groove 41 passes through the ceiling wall 34 along the second axis line Y. The first insertion groove 41 is open in the mating direction in which the first housing 11 is mated with the second housing 110 (in the present embodiment, the forward direction X1). The first insertion groove 41 is open in the upward direction Y1 intersecting the mating direction. The first insertion groove 41 extends along the first axis line X. The first insertion groove 41 extends from the front wall 33 in a mating-opposite direction that is the direction opposite to the mating direction (in the present embodiment, the rearward direction X2). The first insertion groove 41 has a width that is large enough for a first engagement protrusion 82 of a first engagement portion 80 of the lever 50 to be mateable with the first insertion groove 41.

A second insertion groove 42 is provided in the ceiling wall 34. The second insertion groove 42 passes through the ceiling wall 34 along the second axis line Y. The second insertion groove 42 is open in the forward direction X1 and the upward direction Y1. The second insertion groove 42 extends from the front wall 33 along the rearward direction X2. The size of the second insertion groove 42 along the first axis line X is smaller than the size of the first insertion groove 41 along the first axis line X. The second insertion groove 42 has a width that is large enough for the first engagement protrusion 82 of the first engagement portion 80 of the lever 50 to be mateable with the second insertion groove 42.

A groove portion 43 is provided in the ceiling wall 34. The groove portion 43 passes through the ceiling wall 34 along the second axis line Y. The groove portion 43 is formed to partially overlap the groove portion 35 in plan view from the downward direction Y2. The groove portion 43 is open in the forward direction X1 and the upward direction Y1. The groove portion 43 extends from the front wall 33 along the rearward direction X2. The size of the groove portion 43 along the first axis line X is larger than the size of the first insertion groove 41 along the first axis line X.

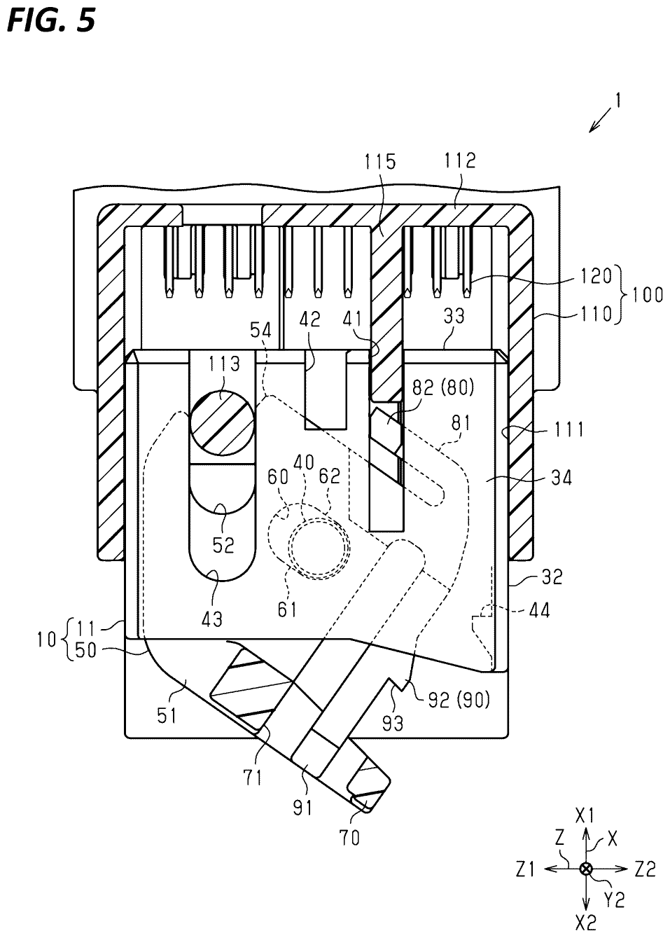

As shown in FIG. 5, the groove portion 43 has a width that is large enough for the shaft portion 113 of the second housing 110 to be mateable with the groove portion 43. The opening width of the groove portion 43, in other words the size of the groove portion 43 along the third axis line Z is set to be slightly larger than the outer diameter of the shaft portion 113. The shaft portion 113 is inserted into the groove portion 43 along the rearward direction X2. The farther end of the groove portion 43, in other words the end portion in the rearward direction X2 of the groove portion 43 is formed in an arc shape in correspondence with the outer peripheral surface of the shaft portion 113 formed in a cylindrical shape.

The first housing 11 includes an engagement protrusion 44 engageable with a second engagement portion 90 of the lever 50. The engagement protrusion 44 is formed to protrude in the first width direction Z1 from the end surface in the first width direction Z1 of the side wall 32 provided on the second width direction Z2 side.

### Configuration of Lever 50

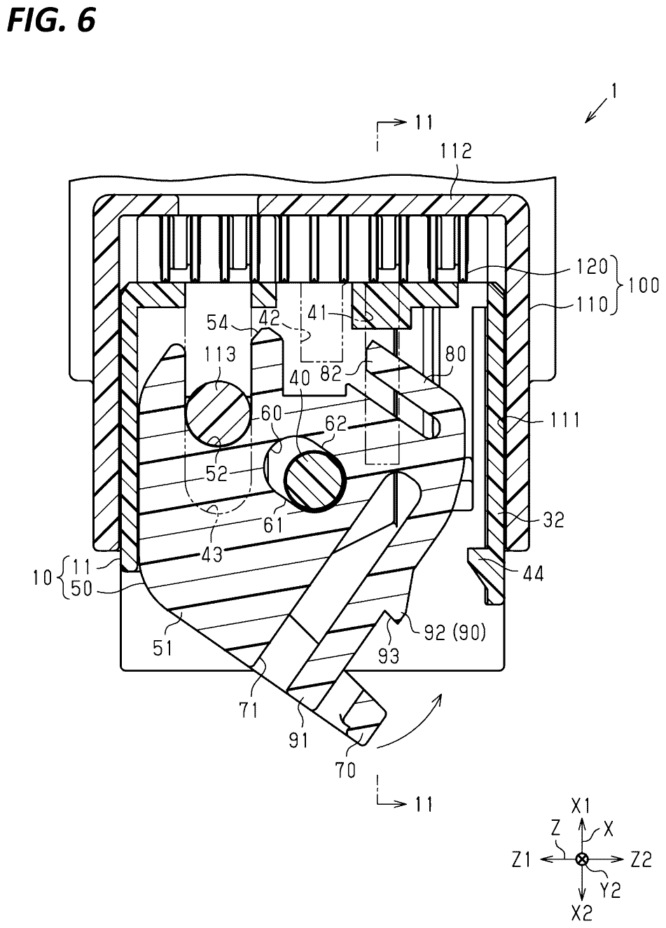

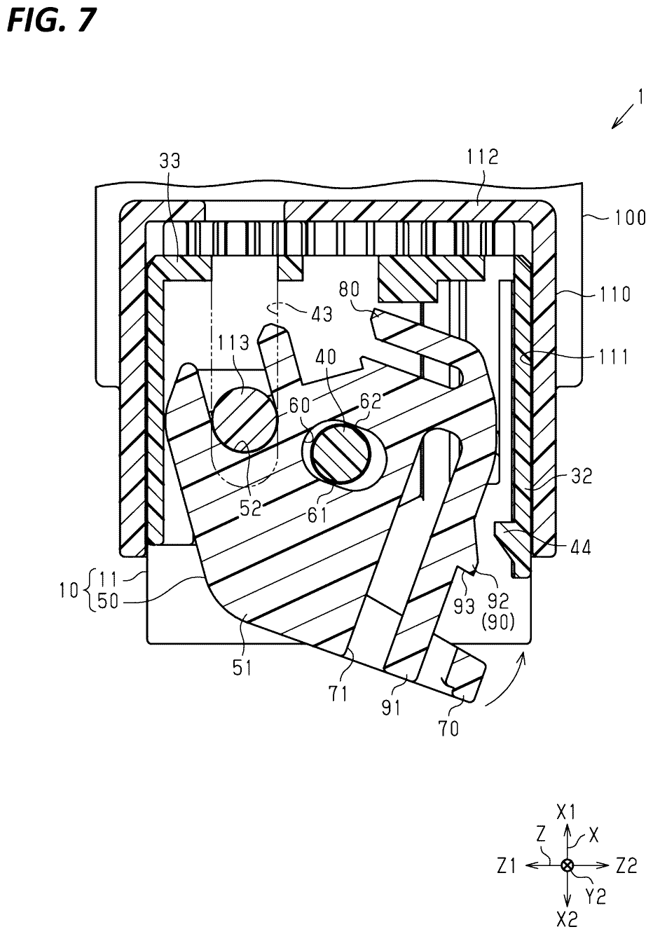

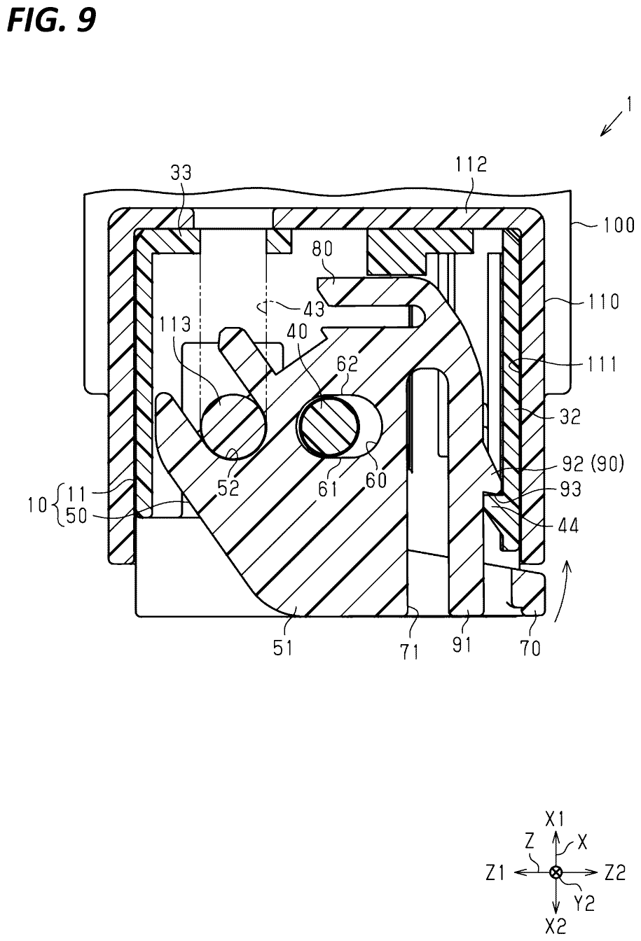

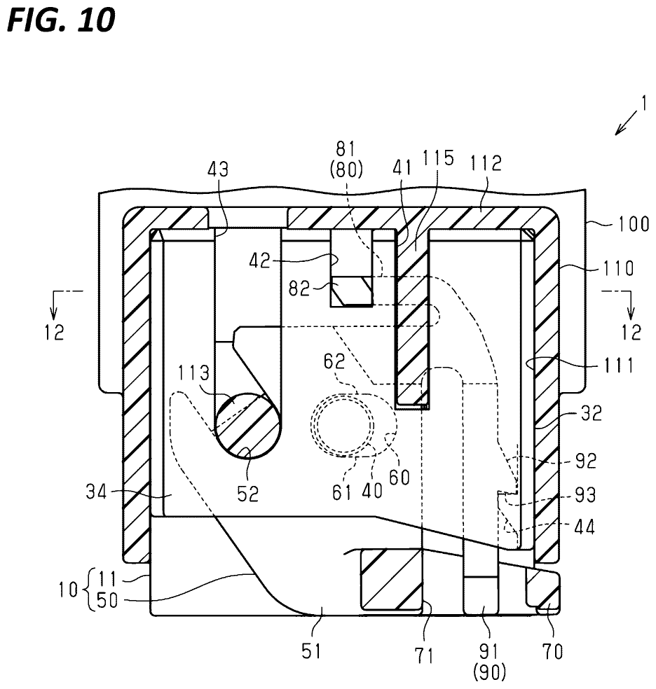

As shown in FIGS. 5 to 10, the lever 50 is attached to the first housing 11 so as to be rotatable between the mating start orientation (see FIGS. 5 and 6) and the mating completion orientation (see FIGS. 9 and 10). When the lever 50 moves from the mating start orientation to the mating completion orientation, the first connector 10 is mated with the second connector 100. Also, when the lever 50 moves from the mating completion orientation to the mating start orientation, the first connector 10 is detached from the second connector 100. In this manner, the first connector 10 is configured to be attachable to and detachable from the second connector 100 in accordance with rotation of the lever 50.

As shown in FIG. 4, the lever 50 includes a body portion 51, a bearing portion 52 provided in the body portion 51, a cam groove 60 provided in the body portion 51, and an operation portion 70. The lever 50 includes the first engagement portion 80 and the second engagement portion 90. The lever 50 is made of a synthetic resin. Note that the lever 50 in FIG. 4 is illustrated as being disposed in the mating completion orientation.

The body portion 51 is formed in a flat plate shape. The body portion 51 extends along the first axis line X and the third axis line Z. The body portion 51 has a thickness in the upward direction Y1. The body portion 51 is formed such that the body portion 51 can be inserted into the housing space S1 of the first housing 11.

The bearing portion 52 is provided at an end portion in the forward direction X1 of the body portion 51 in a state where the lever 50 is disposed in the mating completion orientation. In the mating completion orientation, the bearing portion 52 is provided at the end portion in the first width direction Z1 of the body portion 51. The bearing portion 52 passes through the body portion 51 along the second axis line Y. A bottom portion 53 that blocks the opening in the downward direction Y2 of the bearing portion 52 is provided at the farther end of the bearing portion 52. The bottom portion 53 is formed in a thin plate shape. The bottom portion 53 is thinner than the body portion 51.

As shown in FIGS. 5 and 6, the bearing portion 52 is formed to extend along the first axis line X in a state where the lever 50 is disposed in the mating start orientation. In the mating start orientation, the bearing portion 52 is open in the forward direction X1. The bearing portion 52 is formed to overlap the groove portion 43 of the first housing 11 in plan view from the downward direction Y2, in the mating start orientation. The bearing portion 52 has a width that is large enough for the shaft portion 113 of the second housing 110 to be mateable with the bearing portion 52. The opening width of the bearing portion 52, in other words the size of the bearing portion 52 along the third axis line Z is set to be slightly larger than the outer diameter of the shaft portion 113. The shaft portion 113 is inserted into the bearing portion 52 along the rearward direction X2. The farther end of the bearing portion 52, in other words the end portion in the rearward direction X2 of the bearing portion 52 is formed in an arc shape in correspondence with the outer peripheral surface of the shaft portion 113 formed in a cylindrical shape.

Note that, as shown in FIG. 6, the shaft portion 113 is inserted into the bearing portion 52, in the mating start orientation. The shaft portion 113 according to the present embodiment is inserted into the bearing portion 52 to the farther end thereof, in the mating start orientation.

The body portion 51 includes a guide portion 54 provided at an insertion opening of the bearing portion 52, in other words an opening in the forward direction X1 of the bearing portion 52 in the mating start orientation. The guide portion 54 is provided on the second width direction Z2 side relative to the bearing portion 52. The guide portion 54 is formed such that the opening width of the bearing portion 52 increases as it separates away from the bearing portion 52. The guide portion 54 has a function of smoothly guiding the shaft portion 113 to the inside of the bearing portion 52 when the shaft portion 113 is inserted into the bearing portion 52.

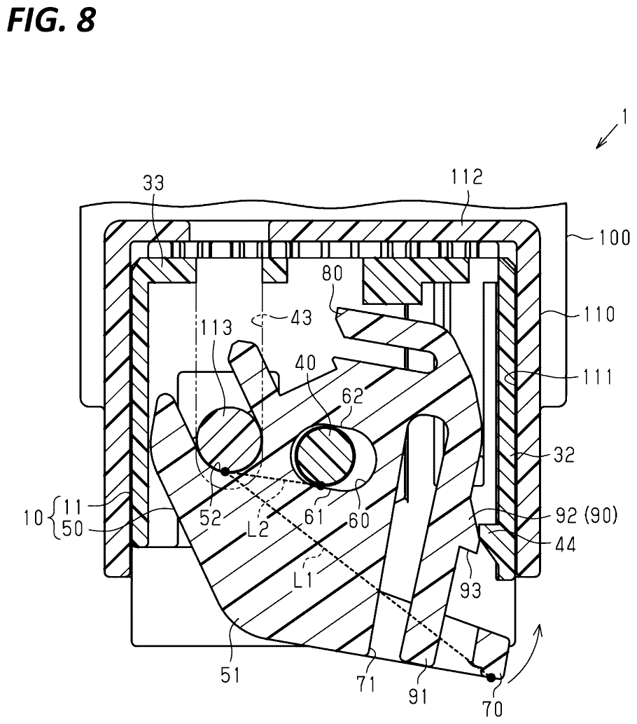

As shown in FIG. 4, the cam groove 60 is provided between the bearing portion 52 and the operation portion 70. The cam groove 60 is provided closer to the bearing portion 52 than to the operation portion 70. A distance L2 between the bearing portion 52 and the cam groove 60 (see FIG. 8) is shorter than the distance between the cam groove 60 and the operation portion 70. The cam groove 60 passes through the body portion 51 along the second axis line Y. The cam groove 60 is formed as an elongated hole. The cam groove 60 is formed as an elongated hole that is longer along the third axis line Z than the first axis line X in the mating completion orientation. The cam groove 60 is formed to have an oblong shape having two parallel lines 61 and 62 and two semicircles in plan view from the downward direction Y2. The two parallel lines 61 and 62 have the same length. In the mating completion orientation, the parallel line 61 is provided at a position further in the rearward direction X2 than the parallel line 62. The cam groove 60 is formed such that the two parallel lines 61 and 62 extend parallel to a second direction orthogonal to the mating direction in which the first housing 11 is mated with the second housing 110 (in the present embodiment, the forward direction X1) when the lever 50 is disposed in the mating completion orientation. Here, the second direction in the present embodiment matches a direction along the third axis line Z. That is to say, the cam groove 60 according to the present embodiment is formed such that the two parallel lines 61 and 62 extend parallel to the third axis line Z in the mating completion orientation. In the mating completion orientation, the cam groove 60 is aligned with the farther end of the bearing portion 52 along the third axis line Z. The cam pin 40 of the first housing 11 is inserted into the cam groove 60. The opening width of the cam groove 60, in other words the shortest distance between the two parallel lines 61 and 62 is set to be slightly longer than the outer diameter of the cam pin 40.

The cam groove 60 is engageable with the cam pin 40. The cam groove 60 causes a force for pressing the first housing 11 into the second housing 110 to act on the cam pin 40 when the lever 50 is rotated about the shaft portion 113 serving as a fulcrum from the mating start orientation to the mating completion orientation.

The operation portion 70 is disposed at the end portion in the rearward direction X2 of the body portion 51 in the mating completion orientation. The operation portion 70 is disposed at an end portion in the second width direction Z2 of the body portion 51 in the mating completion orientation. The operation portion 70 and the bearing portion 52 are provided on a diagonal of the body portion 51 in plan view from the downward direction Y2. In this manner, the bearing portion 52 is provided at a first end portion in a first direction of the lever 50, and the operation portion 70 is provided at a second end portion in the first direction of the lever 50, the first direction intersecting the mating direction (in the present embodiment, the forward direction X1).

In the mating completion orientation, the operation portion 70 protrudes in the second width direction Z2 from a corner portion of the body portion 51. That is to say, in the mating completion orientation, a leading end portion of the operation portion 70 is provided at a position further in the second width direction Z2 than the corner portion of the body portion 51. In the mating completion orientation, the operation portion 70 is formed to extend parallel to the third axis line Z. The operation portion 70 is formed to protrude in the downward direction Y2 from the end surface in the downward direction Y2 of the body portion 51. The operation portion 70 is formed to protrude in the upward direction Y1 from end surface in the upward direction Y1 of the body portion 51. As shown in FIG. 1, the end surface in the upward direction Y1 of the operation portion 70 is either provided flush with the end surface in the upward direction Y1 of the protrusion portion 117 or provided at a position further in the downward direction Y2 than the end surface in the upward direction Y1 of the protrusion portion 117. The operation portion 70 is generally formed as a rectangular parallelepiped. The operation portion 70 is formed to have a rectangular shape in plan view from the forward direction X1.

As shown in FIG. 4, the operation portion 70 includes a through hole 71 that passes through the operation portion 70 in the mating direction (here, the forward direction X1) in the mating completion orientation. The through hole 71 is provided at a central portion of the operation portion 70 in plan view from the forward direction X1. The through hole 71 is formed to have a rectangular shape in plan view from the forward direction X1.

The first engagement portion 80 is formed integrally with the body portion 51. The first engagement portion 80 includes a first flexible piece 81 that is flexibly deformable and the first engagement protrusion 82 provided at a leading end portion of the first flexible piece 81. A base end portion of the first flexible piece 81 is connected to a corner portion of the body portion 51, specifically, an end portion in the forward direction X1 and the second width direction Z2. A major portion of the first flexible piece 81 is formed to extend parallel to the parallel lines 61 and 62 of the cam groove 60. The first flexible piece 81 is formed in a cantilever manner such that the base end portion thereof that is connected to the corner portion of the body portion 51 serves as a fixed end, and a leading end portion that is opposite to the base end portion serves as a free end. The first flexible piece 81 is configured to be flexible in the upward direction Y1 and the downward direction Y2 due to elastic deformation.

The first engagement protrusion 82 is formed to protrude in the upward direction Y1 from the end surface in the upward direction Y1 of the first flexible piece 81. As shown in FIG. 5, the first engagement protrusion 82 is formed to be mated with the first insertion groove 41 of the first housing 11 in the mating start orientation. The first engagement protrusion 82 at this time is engaged with an inner surface of the first insertion groove 41. Due to the engagement between the first engagement protrusion 82 and the inner surface of the first insertion groove 41, rotation of the lever 50 is restricted. Specifically, due to the engagement between the first engagement protrusion 82 and the inner surface of the first insertion groove 41 that faces the second width direction Z2, rotation of the lever 50 in the first rotational direction from the mating start orientation toward the mating completion orientation is restricted. In addition, due to the engagement between the first engagement protrusion 82 and the inner surface of the first insertion groove 41 that faces the first width direction Z1, rotation of the lever 50 in the second rotational direction that is the opposite direction to the first rotational direction, namely the second direction from the mating completion orientation toward the mating start orientation, is restricted.

As shown in FIG. 2, the first engagement protrusion 82 mated with the first insertion groove 41 is exposed to the outside of the first housing 11. For this reason, whether or not the first engagement protrusion 82 is mated with the first insertion groove 41 can be visually recognized from the outside of the first housing 11.

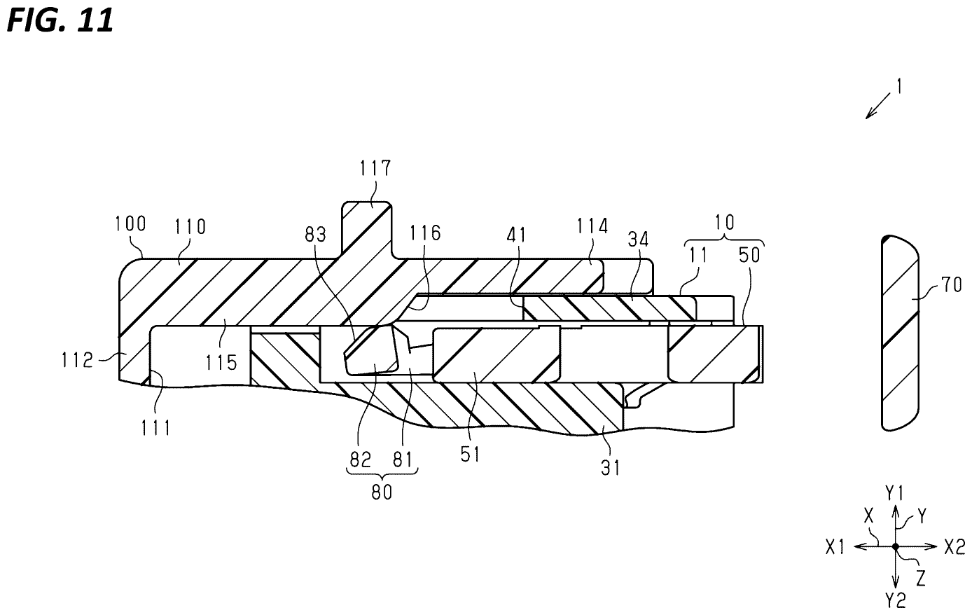

As shown in FIG. 11, when the disengagement portion 115 of the second housing 110 is inserted into the first insertion groove 41, the first engagement protrusion 82 is pressed in the downward direction Y2 by the disengagement portion 115. The first flexible piece 81 then flexes in the downward direction Y2, and the first engagement protrusion 82 and the inner surface of the first insertion groove 41 are disengaged from each other. Accordingly, rotation of the lever 50 is allowed. Here, the first engagement protrusion 82 includes an inclined surface 83 that faces the inclined surface 116 of the disengagement portion 115. The inclined surface 83 is an end surface of the first engagement protrusion 82 that faces the forward direction X1, and is provided at the end portion in the upward direction Y1 of the first engagement protrusion 82. The inclined surface 83 is formed to be inclined in the rearward direction X2 toward the end surface in the upward direction Y1 of the first engagement protrusion 82. When the disengagement portion 115 is inserted into the first insertion groove 41, the first flexible piece 81 starts to flex in the downward direction Y2 by the inclined surface 116 of the disengagement portion 115 being brought into contact with the inclined surface 83 of the first engagement protrusion 82.

As shown in FIG. 10, the first engagement protrusion 82 is formed to be mated with the second insertion groove 42 of the first housing 11 in the mating completion orientation. The first engagement protrusion 82 at this time is engaged with the inner surface of the second insertion groove 42. Due to engagement between the first engagement protrusion 82 and the inner surface of the second insertion groove 42, rotation of the lever 50 is restricted. Specifically, due to engagement between the first engagement protrusion 82 and the inner surface of the second insertion groove 42 that faces the second width direction Z2, rotation of the lever 50 in the first rotational direction is restricted. In addition, due to engagement between the first engagement protrusion 82 and the inner surface of the second insertion groove 42 that faces the first width direction Z1, rotation of the lever 50 in the second rotational direction is restricted.

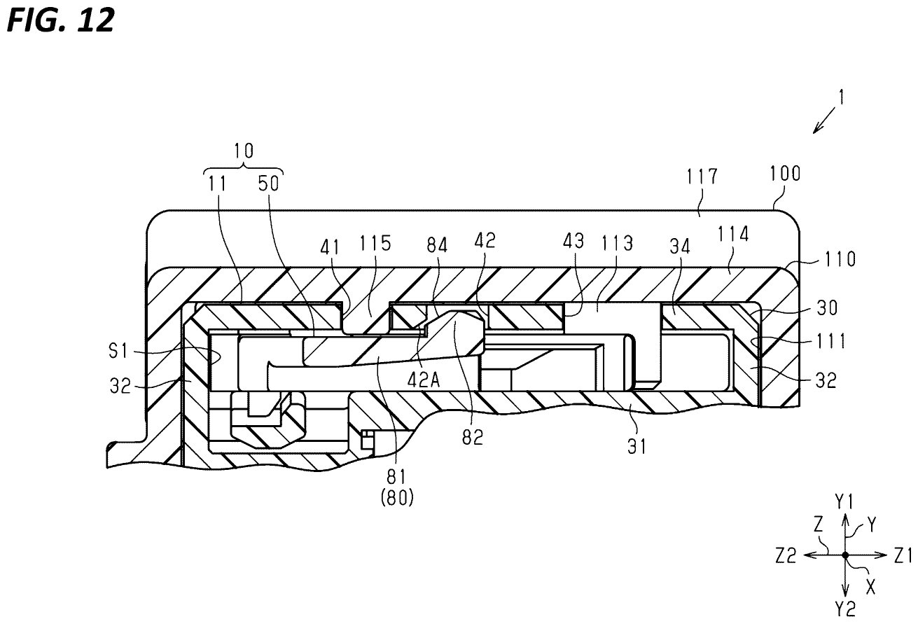

As shown in FIG. 12, the first engagement protrusion 82 includes an inclined surface 84 that faces the inner surface of the second insertion groove 42 that faces the first width direction Z1. The inclined surface 84 is an end surface of the first engagement protrusion 82 that faces the second width direction Z2, and is provided at the end portion in the upward direction Y1 of the first engagement protrusion 82. The inclined surface 84 is formed to be inclined in the first width direction Z1 toward the end surface in the upward direction Y1 of the first engagement protrusion 82. Here, the inner surface of the second insertion groove 42 that faces the first width direction Z1 includes an inclined surface 42A that faces the inclined surface 84. The inclined surface 42A is provided at the end portion in the downward direction Y2 of the ceiling wall 34. The inclined surface 42A is formed to be inclined in the second width direction Z2 toward the end surface in the downward direction Y2 of the ceiling wall 34. By providing the inclined surfaces 42A and 84, the first engagement protrusion 82 and the inner surface of the second insertion groove 42 are easily disengaged from each other when the lever 50 is rotated in the second rotational direction. Note that an inclined surface similar to the inclined surface 42A is not formed on the inner surface of the first insertion groove 41 and the inner surface of the second insertion groove 42 that faces the second width direction Z2.

As shown in FIG. 4, the second engagement portion 90 is formed integrally with the body portion 51. The second engagement portion 90 includes a second flexible piece 91 that is flexibly deformable and a second engagement protrusion 92 that protrudes from the second flexible piece 91. A base end portion of the second flexible piece 91 is a corner portion of the body portion 51, specifically, an end portion in the forward direction X1 of the body portion 51, and is connected to an end portion in the second width direction Z2. The base end portion of the second flexible piece 91 is connected to a base end portion of the first flexible piece 81. In the mating completion orientation, the lengthwise direction of the second flexible piece 91 matches the mating direction in which the first housing 11 is mated with the second housing 110 (in the present embodiment, the forward direction X1). The second flexible piece 91 is formed in a cantilever manner such that the base end portion thereof that is connected to the corner portion of the body portion 51 serves as a fixed end, and a leading end portion that is opposite to the base end portion serves as a free end. The second flexible piece 91 is configured to be flexible in the first width direction Z1 and the second width direction Z2 due to elastic deformation. The leading end portion of the second flexible piece 91 extends to the operation portion 70. The leading end portion of the second flexible piece 91 is inserted into the through hole 71 of the operation portion 70.

The second engagement protrusion 92 is provided at an intermediate position in the lengthwise direction of the second flexible piece 91. The second engagement protrusion 92 protrudes in a third direction intersecting the lengthwise direction of the second flexible piece 91. The second engagement protrusion 92 according to the present embodiment is formed to protrude in the second width direction Z2 from the end surface of the second flexible piece 91 that faces the second width direction Z2, in the mating completion orientation. The second engagement protrusion 92 includes an engagement surface 93 that faces the operation portion 70. The engagement surface 93 is formed to face the rearward direction X2 in the mating completion orientation. The engagement surface 93 is formed on a plane orthogonal to both the lengthwise direction of the second flexible piece 91 and the protrusion direction of the second engagement protrusion 92.

As shown in FIG. 9, in the mating completion orientation, the engagement surface 93 is engaged with the engagement protrusion 44 of the first housing 11. In the mating completion orientation, due to engagement between the engagement surface 93 and the engagement protrusion 44, rotation of the lever 50 in the second rotational direction is restricted.

When the lever 50 is rotated from the mating completion orientation to the mating start orientation, the engagement surface 93 and the engagement protrusion 44 are disengaged from each other by the second flexible piece 91 being flexed in the first width direction Z1. At this time, an operation of flexing the second flexible piece 91 is easily performed from the outside of the first housing 11 since the second flexible piece 91 extends to the operation portion 70.

The above-described lever 50 is formed to be smaller than the second housing 110 along the third axis line Z. For example, in the mating completion orientation, the maximum size of the lever 50 along the third axis line Z is smaller than the maximum size of the second housing 110 along the third axis line Z.

### Method for Mating First Connector 10 and Second Connector 100 With Each Other

Next, a method for mating the first connector 10 and the second connector 100 with each other will be described.

First, as shown in FIG. 2, the first housing 11 to which the lever 50 is attached is prepared. The lever 50 at this time is held in the mating start orientation. Here, the mating start orientation according to the present embodiment is, for example, orientation of the lever 50 rotated about the shaft portion 113 (see FIG. 3) in the second rotational direction by 35° from the mating completion orientation set to 0°. As shown in FIG. 5, when the lever 50 is in the mating start orientation, the cam pin 40 of the first housing 11 is inserted into the cam groove 60 of the lever 50, and the cam pin 40 is disposed at the end portion in the second width direction Z2 of the cam groove 60. In this manner, the cam pin 40 is inserted into the cam groove 60, and the first connector 10 and the second connector 100 then start to be mated with each other. In the mating start orientation, rotation of the lever 50 toward the mating completion orientation is restricted by the first engagement protrusion 82 of the first engagement portion 80 of the lever 50 being engaged with the inner surface of the first insertion groove 41 of the first housing 11. In addition, in the mating start orientation, the bearing portion 52 of the lever 50 is provided at a position overlapping the groove portion 43 of the first housing 11 in plan view from the downward direction Y2. At this time, the bearing portion 52 faces the direction along the first axis line X.

Next, the first housing 11 to which the lever 50 has been attached is brought relatively close to the second housing 110. The first housing 11 to which the lever 50 has been attached is then mated into the mating recessed portion 111 of the second housing 110. At this time, the shaft portion 113 of the second housing 110 is inserted into the bearing portion 52 of the lever 50 along the rearward direction X2, and is inserted into the groove portion 43 of the first housing 11 along the rearward direction X2. In addition, the disengagement portion 115 of the second housing 110 is inserted into the first insertion groove 41 of the first housing 11 along the rearward direction X2. In the state shown in FIG. 5, the first engagement protrusion 82 is still engaged with the inner surface of the first insertion groove 41, and thus rotation of the lever 50 toward the mating completion orientation, in other words in the first rotational direction is restricted.

Next, as shown in FIG. 11, as the first housing 11 and the second housing 110 are further mated with each other, the first engagement protrusion 82 is pressed in the downward direction Y2 by the disengagement portion 115. Accordingly, the first flexible piece 81 elastically deforms and flexes in the downward direction Y2. Then, the first engagement protrusion 82 and the inner surface of the first insertion groove 41 are disengaged from each other, and rotation of the lever 50 in the first rotational direction is allowed. At this time, as shown in FIG. 6, the shaft portion 113 of the second housing 110 is in a state of being inserted into the bearing portion 52 of the lever 50. Specifically, at least a diameter portion of the shaft portion 113 along the third axis line Z is in a state of being inserted into the bearing portion 52. In the present embodiment, when the first engagement protrusion 82 and the inner surface of the first insertion groove 41 are disengaged from each other due to the disengagement portion 115, the shaft portion 113 is in a state of being inserted into the bearing portion 52 to the farther end thereof. In addition, in a state of being inserted into the bearing portion 52 to the farther end thereof, the shaft portion 113 is inserted into the groove portion 43 of the first housing 11 to an intermediate position in the lengthwise direction thereof.

Next, as shown in FIGS. 6 to 10, an operating force is applied to the operation portion 70 of the lever 50, specifically, an operation of pressing the operation portion 70 toward the first housing 11 is performed (see the arrow in the figures). Accordingly, the lever 50 is rotated from the mating start orientation (see FIG. 6) to the mating completion orientation (see FIGS. 9 and 10). Then, the lever 50 rotates about the shaft portion 113, and the cam pin 40 relatively moves within the cam groove 60 that is an elongated hole. At this time, due to cam action caused by engagement between the cam pin 40 and the inner surface of the cam groove 60, a mating force is applied between the first housing 11 and the second housing 110. To describe it in detail, the inner surface of the cam groove 60, specifically, the inner surface of the cam groove 60 corresponding to the parallel line 61 is engaged with the cam pin 40, and a force for pressing the first housing 11 into the second housing 110 acts on the cam pin 40. Accordingly, the first housing 11 is pressed into the second housing 110, and the first housing 11 and the second housing 110 are further mated with each other. In this manner, the lever 50 is configured as a second-class lever in which the operation portion 70 serves as an effort point, the bearing portion 52 into which the shaft portion 113 is inserted serves as a fulcrum, and the cam groove 60 into which the cam pin 40 is inserted serves as a load point. For this reason, an amplified lever force is achieved by rotating the lever 50. Note that, as shown in FIG. 8, when the distance between the bearing portion 52 serving as a fulcrum and the operation portion 70 serving as an effort point is denoted by L1, and the distance between the bearing portion 52 serving as a fulcrum and the cam groove 60 serving as a load point is denoted by L2, L1/L2 is defined as a lever ratio.

As shown in FIGS. 6 to 10, as a result of the above pressing force acting on the cam pin 40 when the lever 50 rotates from the mating start orientation to the mating completion orientation, the cam pin 40 is relatively moved from the end portion in the second width direction Z2 of the cam groove 60 toward the end portion in the first width direction Z1. In addition, when the lever 50 rotates from the mating start orientation to the mating completion orientation, the first housing 11 is pressed into the second housing 110, and thereby the shaft portion 113 inserted into the bearing portion 52 to the farther end thereof is relatively moved toward the farther end of the groove portion 43. As shown in FIG. 9, when the lever 50 rotates to the mating completion orientation, the shaft portion 113 inserted into the bearing portion 52 to the farther end thereof is disposed at the farther end of the groove portion 43, in other words the end portion in the rearward direction X2 of the groove portion 43. At this time, the shaft portion 113 is aligned with the cam pin 40 along the third axis line Z.

As shown in FIG. 10, when the lever 50 rotates to the mating completion orientation, the first housing 11 and the second housing 110 come into a normal mated state in which they are completely mated with each other. In the normal mated state, the first housing 11 is inserted into the mating recessed portion 111 of the second housing 110 to the farther wall 112 thereof. Although not illustrated, in the normal mated state, the first terminals of the first connector 10 and the second terminals 120 of the second connector 100 (see FIG. 1) are electrically connected to each other, respectively. In addition, in the normal mated state, the first engagement protrusion 82 of the first engagement portion 80 of the lever 50 is engaged with the inner surface of the second insertion groove 42 of the first housing 11, and the second engagement protrusion 92 of the second engagement portion 90 of the lever 50 is engaged with the engagement protrusion 44 of the first housing 11. Accordingly, rotation of the lever 50 toward the mating start orientation is restricted, and the lever 50 is locked in a state of being disposed in the mating completion orientation. In this manner, in the normal mated state, due to engagement between the first engagement protrusion 82 and the inner surface of the second insertion groove 42 and engagement between the second engagement protrusion 92 and the engagement protrusion 44, rotation of the lever 50 is restricted, and thereby the normal mated state of the first housing 11 and the second housing 110 is maintained.

Note that, when the first connector 10 is detached from the second connector 100, the second flexible piece 91 of the lever 50 is first flexed in the first width direction Z1. Accordingly, the second engagement protrusion 92 and the engagement protrusion 44 are disengaged from each other, and rotation of the lever 50 toward the mating start orientation is allowed. Next, the operation portion 70 of the lever 50 is operated to rotate the lever 50 from the mating completion orientation (see FIGS. 9 and 10) toward the mating start orientation (see FIG. 6). Then, the lever 50 rotates about the shaft portion 113, and the cam pin 40 relatively moves within the cam groove 60 that is an elongated hole. At this time, due to the cam action caused by engagement between the cam pin 40 and the inner surface of the cam groove 60, a detachment force is applied between the first housing 11 and the second housing 110. To describe it in detail, the inner surface of the cam groove 60, specifically the inner surface of the cam groove 60 corresponding to the parallel line 62 is engaged with the cam pin 40, and a force for pulling the first housing 11 away from the second housing 110 acts on the cam pin 40. Accordingly, the first housing 11 is pulled away from the second housing 110, and the first housing 11 and the second housing 110 are further detached from each other. In this manner, the lever 50 is configured as a second-class lever in which the operation portion 70 serves as an effort point, the bearing portion 52 into which the shaft portion 113 is inserted serves as a fulcrum, and the cam groove 60 into which the cam pin 40 is inserted serves as a load point.

### Operations and Effects of Present Embodiment

Next, operations and effects of the present embodiment will be described.
(1) The connector assembly 1 includes the first connector 10 and the second connector 100 that is to be mated with the first connector 10. The first connector 10 includes the first housing 11 and the lever 50 that is attached to the first housing 11 so as to be rotatable between the mating start orientation and the mating completion orientation. The second connector 100 includes the second housing 110 that is mateable with the first housing 11. The first housing 11 includes the cam pin 40. The second housing 110 includes the shaft portion 113. The lever 50 includes the operation portion 70 serving as an effort point, the cam groove 60 into which the cam pin 40 is inserted and that is engageable with the cam pin 40, and the bearing portion 52 into which the shaft portion 113 is to be inserted. The cam groove 60 is formed in an elongated hole, and is provided between the operation portion 70 and the bearing portion 52. The cam groove 60 causes a force for pressing the first housing 11 into the second housing 110 to act on the cam pin 40 when the lever 50 is rotated about the bearing portion 52 serving as a fulcrum from the mating start orientation to the mating completion orientation.

With this configuration, the cam groove 60 provided in the lever 50 is provided between the operation portion 70 and the bearing portion 52. For this reason, the lever 50 is provided with the operation portion 70 serving as an effort point and the bearing portion 52 serving as a fulcrum, which are disposed with the cam groove 60 serving as a load point therebetween. Therefore, compared with a conventional configuration in which a bearing portion serving as a fulcrum is provided between an operation portion and a cam groove, the distance L1 between the bearing portion 52 serving as a fulcrum and the operation portion 70 serving as an effort point can be set to be long, and the lever ratio L1/L2 can be set to be large. Accordingly, even if the sizes of the first connector 10 and the second connector 100 are reduced, it is possible to suitably exert a force amplification effect of the lever 50, and mate the first connector 10 and the second connector 100 with each other by operating the lever 50 with a small operating force. As a result, even if the sizes of the first connector 10 and the second connector 100 are reduced, it is possible to suitably reduce an operating force of the lever 50 when mating the first connector 10 and the second connector 100 with each other. For example, even if the sizes of the first connector 10 and the second connector 100 are reduced in the direction along the third axis line Z, it is possible to suitably reduce an operating force of the lever 50.
(2) The cam groove 60 is formed in an elongated hole. When the lever 50 rotates between the mating start orientation and the mating completion orientation, the cam pin 40 is moved within the cam groove 60. On the other hand, when the lever 50 rotates between the mating start orientation and the mating completion orientation, the position of the shaft portion 113 that is inserted into the bearing portion 52 serving as a fulcrum is fixed. Accordingly, the cam pin 40 is moved within the cam groove 60 provided between the shaft portion 113 whose position is fixed and the operation portion 70, and thus it is possible to suppress an increase in the movable range of the lever 50 outward of the shaft portion 113. For example, compared with a configuration in which the position of the fulcrum is displaced in the direction along the third axis line Z when the lever 50 rotates, it is possible to suppress an increase in the movable range of the lever 50 in the direction along the third axis line Z.
(3) The distance L2 between the bearing portion 52 and the cam groove 60 is shorter than the distance between the cam groove 60 and the operation portion 70. With this configuration, the distance L1 between the bearing portion 52 and the operation portion 70 can be set to be long, and the distance L2 between the bearing portion 52 and the cam groove 60 can be set to be short. Accordingly, the lever ratio L1/L2 can be set to be larger. As a result, even if the sizes of the first connector 10 and the second connector 100 are reduced, it is possible to suitably reduce an operating force of the lever 50.
(4) The lever 50 includes a first end portion and a second end portion in a first direction intersecting a mating direction in which the first housing 11 is mated with the second housing 110 (in the present embodiment, the forward direction X1). The bearing portion 52 is provided at the first end portion of the lever 50. The operation portion 70 is provided at the second end portion of the lever 50.

With this configuration, the distance L1 between the bearing portion 52 serving as a fulcrum and the operation portion 70 serving as an effort point can be set to be longer, and the lever ratio L1/L2 can be set to be larger. As a result, even if the sizes of the first connector 10 and the second connector 100 are reduced, it is possible to suitably reduce an operating force of the lever 50.
(5) The cam groove 60 is formed in an oblong shape having the two parallel lines 61 and 62 and the two semicircles in plan view. The cam pin 40 is formed in a cylindrical shape. The cam groove 60 is formed such that the shortest distance between the two parallel lines 61 and 62 is longer than the diameter of the cam pin 40. The cam groove 60 is formed such that the two parallel lines 61 and 62 extend parallel to the second direction orthogonal to the mating direction when the lever 50 is disposed in the mating completion orientation.

With this configuration, when the lever 50 is disposed in the mating completion orientation, the two parallel lines 61 and 62 of the cam groove 60 extend parallel to the second direction orthogonal to the mating direction (in the present embodiment, the first width direction Z1). Accordingly, it is possible to cause a force for pressing the first housing 11 into the second housing 110 (in other words, a pressing force along the mating direction) to act on the cam pin 40 using a surface orthogonal to the mating direction at the time of mating completion. Therefore, at the time of mating completion when a pressing force along the mating direction is most necessary, it is possible to cause the largest pressing force to act on the cam pin 40 using the surface orthogonal to the mating direction. As a result, it is possible to suitably reduce the operating force of the lever 50 immediately before mating completion.
(6) The lever 50 includes the first engagement portion 80. The first housing 11 includes the first insertion groove 41 for restricting rotation of the lever 50 in the first rotational direction from the mating start orientation toward the mating completion orientation. The first insertion groove 41 is engageable with the first engagement portion 80 when the lever 50 is disposed in the mating start orientation.

With this configuration, when the lever 50 is disposed in the mating start orientation, the first engagement portion 80 of the lever 50 is engaged with the first insertion groove 41 of the first housing 11. Due to engagement between the first engagement portion 80 and first insertion groove 41, it is possible to restrict rotation of the lever 50 in the first rotational direction from the mating start orientation toward the mating completion orientation. As a result, it is possible to suitably suppress unintentional rotation of the lever 50 in the first rotational direction in a state where the lever 50 is disposed in the mating start orientation.
(7) The second housing 110 includes the mating recessed portion 111 into which the first housing 11 is mated, and the farther wall 112 provided at the farther end of the mating recessed portion 111. The first engagement portion 80 includes the first flexible piece 81 that is flexibly deformable and the first engagement protrusion 82 that protrudes from the first flexible piece 81. The first housing 11 includes the front wall 33 facing the farther wall 112, and the first insertion groove 41 with which the first engagement protrusion 82 is to be mated. The first insertion groove 41 is open in the mating direction. The first insertion groove 41 extends from the front wall 33 in a mating-opposite direction that is a direction opposite to the mating direction (in the present embodiment, the rearward direction X2). The second housing 110 includes the disengagement portion 115 that is inserted into the first insertion groove 41 in the mating-opposite direction and disengage the inner surface of the first insertion groove 41 and the first engagement protrusion 82 from each other.

With this configuration, as the first housing 11 and the second housing 110 are mated with each other, the disengagement portion 115 provided in the second housing 110 is inserted into the first insertion groove 41 along the mating-opposite direction. Due to this disengagement portion 115, the inner surface of the first insertion groove 41 and the first engagement protrusion 82 of the first engagement portion 80 are disengaged from each other. When the inner surface of the first insertion groove 41 and the first engagement protrusion 82 are disengaged from each other in this manner, it is possible to allow rotation of the lever 50 in the first rotational direction from the mating start orientation toward the mating completion orientation.
(8) The shaft portion 113 is formed to be accommodated in the bearing portion 52 when the inner surface of the first insertion groove 41 and the first engagement protrusion 82 are disengaged from each other due to the disengagement portion 115. With this configuration, when rotation of the lever 50 in the first rotational direction is allowed, the shaft portion 113 serving as a fulcrum can be accommodated in the bearing portion 52. Accordingly, it is possible to suitably keep the shaft portion 113 from coming loose from the bearing portion 52 when the lever 50 rotates in the first rotational direction.
(9) The lever 50 includes the second engagement portion 90. The first housing 11 includes the engagement protrusion 44 for restricting rotation of the lever 50 in the second rotational direction from the mating completion orientation toward the mating start orientation. The engagement protrusion 44 is engageable with the second engagement portion 90 when the lever 50 is disposed in the mating completion orientation.

With this configuration, when the lever 50 is disposed in the mating completion orientation, the second engagement portion 90 of the lever 50 is engaged with the engagement protrusion 44 of the first housing 11. Due to engagement between the second engagement portion 90 and engagement protrusion 44, it is possible to restrict rotation of the lever 50 in the second rotational direction from the mating completion orientation toward the mating start orientation. As a result, it is possible to suitably suppress unintentional rotation of the lever 50 in the second rotational direction in a state where the lever 50 is disposed in the mating completion orientation.
(10) The second engagement portion 90 includes the second flexible piece 91 that is flexibly deformable and the second engagement protrusion 92 that protrudes from the second flexible piece 91. The lengthwise direction of the second flexible piece 91 matches the mating direction in a state where the lever 50 is disposed in the mating completion orientation. The second engagement protrusion 92 is provided at an intermediate position in the lengthwise direction of the second flexible piece 91. The second engagement protrusion 92 protrudes in the third direction intersecting the lengthwise direction of the second flexible piece 91. The operation portion 70 includes the through hole 71 that passes through the operation portion 70 in the mating direction. The second flexible piece 91 extends from the second engagement protrusion 92 to the inside of the through hole 71.

With this configuration, the second engagement protrusion 92 and the engagement protrusion 44 can be disengaged from each other by flexing the second flexible piece 91. Accordingly, the lever 50 can be suitably rotated in the second rotational direction when the first housing 11 is detached from the second housing 110. In addition, since the second flexible piece 91 extends to the inside of the through hole 71 provided in the operation portion 70, it is possible to easily perform an operation of the second flexible piece 91, in other words an operation of disengaging the second engagement protrusion 92 and the engagement protrusion 44 from each other.
(11) Furthermore, the through hole 71 is provided in the operation portion 70, and the leading end portion of the second flexible piece 91 is inserted into the through hole 71. Accordingly, it is possible to improve the operability of the second flexible piece 91 although the operation portion 70 is formed to be large.

### Modified Example

The above embodiment can be modified and implemented as follows. The above embodiment and the modified examples described below can be combined unless they are technically inconsistent.
It is possible to change the structure of the lever 50 according to the above embodiment as appropriate.
In the above embodiment, the operation portion 70 is formed to protrude further in the downward direction Y2 than the end surface in the downward direction Y2 of the body portion 51, but there is no limitation thereto. For example, the end surface in the downward direction Y2 of the operation portion 70 may be formed to be flush with the end surface in the downward direction Y2 of the body portion 51.
In the above embodiment, the operation portion 70 is formed to protrude further in the upward direction Y1 than the end surface in the upward direction Y1 of the body portion 51, but there is no limitation thereto. For example, the end surface in the upward direction Y1 of the operation portion 70 may be formed to be flush with the end surface in the upward direction Y1 of the body portion 51.
The through hole 71 of the operation portion 70 may be omitted. In this case, for example, the leading end portion of the second flexible piece 91 may be provided further in the second width direction Z2 than the operation portion 70.
In the above embodiment, a configuration is adopted in which the base end portion of the first flexible piece 81 and the base end portion of the second flexible piece 91 are connected to each other, but there is no limitation thereto. For example, the base end portion of the first flexible piece 81 and the base end portion of the second flexible piece 91 may be individually connected to the body portion 51.
The inclined surface 83 of the first engagement protrusion 82 may be omitted. . . .
The inclined surface 84 of the first engagement protrusion 82 may be omitted.
In the above embodiment, the cam groove 60 is formed to have an oblong shape in plan view, but there is no limitation thereto. For example, the cam groove 60 may be formed to have an elliptical shape or a rectangular shape in plan view.
It suffices for the bearing portion 52 according to the above embodiment to be configured such that the shaft portion 113 can be inserted thereinto, and the shaft portion 113 does not need to pass through the body portion 51 along the second axis line Y.
It is possible to change the structure of the first housing 11 according to the above embodiment as appropriate.
In the above embodiment, the first insertion groove 41 is formed to be open in the upward direction Y1. There is no limitation thereto, and the first insertion groove 41 may be formed to block the opening in the upward direction Y1.
In the above embodiment, the second insertion groove 42 is formed to be open in the upward direction Y1. There is no limitation thereto, and the second insertion groove 42 may be formed to block the opening in the upward direction Y1.
The inclined surface 42A of the second insertion groove 42 according to the above embodiment may be omitted.
In the above embodiment, the groove portion 43 is formed to be open in the upward direction Y1. There is no limitation thereto, and the groove portion 43 may be formed to block the opening in the upward direction Y1.
The groove portion 43 may be omitted.
The groove portion 35 may be omitted.
In the above embodiment, a second restriction portion is embodied as the engagement protrusion 44, but there is no limitation thereto. For example, the second restriction portion may be embodied as a groove portion that is to be mated with the second engagement protrusion 92 of the second engagement portion 90.
The engagement protrusion 44 may be omitted.
It is possible to change the structure of the second housing 110 according to the above embodiment as appropriate.
The protrusion portion 117 may be omitted.
The embodiment disclosed herein is exemplary in all respects and should not be interpreted as limiting in any manner. The scope of the present invention is not limited to the above meanings, but rather is indicated by the claims, and is intended to include all modifications that are within the meanings and the scope that are equivalent to those of the claims.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A first connector comprising:
a first housing that is mateable with a second housing of a second connector; and
a lever that is attached to the first housing so as to be rotatable between mating start orientation and mating completion orientation,
wherein the first housing includes a cam pin,
the lever includes an operation portion serving as an effort point, a cam groove into which the cam pin is inserted and that is engageable with the cam pin, and a bearing portion into which a shaft portion provided in the second housing is inserted,
the cam groove is formed in an elongated hole, and is provided between the operation portion and the bearing portion, and
the cam groove causes a force for pressing the first housing into the second housing to act on the cam pin when the lever is rotated about the bearing portion serving as a fulcrum from the mating start orientation to the mating completion orientation.

2. A connector assembly comprising:
a first connector; and
a second connector that is to be mated with the first connector,
wherein the first connector includes:
a first housing that includes a cam pin; and
a lever that is attached to the first housing so as to be rotatable between mating start orientation and mating completion orientation,
the second connector includes:
a second housing that is mateable with the first housing; and
a shaft portion,
the lever includes an operation portion serving as an effort point, a cam groove into which the cam pin is to be inserted and that is engageable with the cam pin, and a bearing portion into which the shaft portion is to be inserted,
the cam groove is formed in an elongated hole, and is provided between the operation portion and the bearing portion, and
the cam groove causes a force for pressing the first housing into the second housing to act on the cam pin when the lever is rotated about the bearing portion serving as a fulcrum from the mating start orientation to the mating completion orientation.

3. The connector assembly according to claim 2,
wherein a distance between the bearing portion and the cam groove is shorter than a distance between the cam groove and the operation portion.

4. The connector assembly according to claim 2,
wherein the lever includes a first end portion and a second end portion in a first direction intersecting a mating direction in which the first housing is mated with the second housing,
the bearing portion is provided at the first end portion, and
the operation portion is provided at the second end portion.

5. The connector assembly according to claim 2,
wherein the cam groove is formed to have an oblong shape having two parallel lines and two semicircles in plan view,
the cam pin is formed in a cylindrical shape,
the shortest distance between the two parallel lines is longer than a diameter of the cam pin, and
the cam groove is formed such that, when the lever is disposed in the mating completion orientation, the two parallel lines extend parallel to a second direction orthogonal to a mating direction in which the first housing is mated with the second housing.

6. The connector assembly according to claim 2,
wherein the lever includes a first engagement portion,
the first housing includes a first restriction portion for restricting rotation of the lever in a first rotational direction from the mating start orientation to the mating completion orientation, and
the first restriction portion is engageable with the first engagement portion when the lever is disposed in the mating start orientation.

7. The connector assembly according to claim 6,
wherein the second housing includes: a mating recessed portion into which the first housing is to be mated and a farther wall provided at a farther end of the mating recessed portion,
the first engagement portion includes a first flexible piece that is flexibly deformable and a first engagement protrusion that protrudes from the first flexible piece,
the first housing includes a front wall facing the farther wall, and a first insertion groove with which the first engagement protrusion is to be mated,
the first insertion groove is open in a mating direction in which the first housing is mated with the second housing,
the first insertion groove extends from the front wall along a mating-opposite direction that is a direction opposite to the mating direction,
the first restriction portion is formed by an inner surface of the first insertion groove, and
the second housing includes a disengagement portion that is inserted into the first insertion groove along the mating-opposite direction and disengages the first restriction portion and the first engagement protrusion from each other.

8. The connector assembly according to claim 7,
wherein the shaft portion is formed to be accommodated in the bearing portion when the first restriction portion and the first engagement protrusion are disengaged from each other due to the disengagement portion.

9. The connector assembly according to claim 2,
wherein the lever includes a second engagement portion,
the first housing includes a second restriction portion for restricting rotation of the lever in a second rotational direction from the mating completion orientation toward the mating start orientation, and
the second restriction portion is engageable with the second engagement portion when the lever is disposed in the mating completion orientation.

10. The connector assembly according to claim 9,
wherein the second engagement portion includes a second flexible piece that is flexibly deformable and a second engagement protrusion that protrudes from the second flexible piece and is engageable with the second restriction portion,
a lengthwise direction of the second flexible piece matches a mating direction in which the first housing is mated with the second housing in a state where the lever is disposed in the mating completion orientation,
the second engagement protrusion is provided at an intermediate position in the lengthwise direction of the second flexible piece,
the second engagement protrusion protrudes in a third direction intersecting the lengthwise direction of the second flexible piece,
the operation portion includes a through hole that passes through the operation portion in the mating direction, and
the second flexible piece extends from the second engagement protrusion to the inside of the through hole.
